(19) United States
(12) Patent Application Publication
(10) Pub. No.: US 2002/0018500 A1
(43) Pub. Date: Feb. 14, 2002

(54) Semiconductor laser unit and semiconductor laser module

(75) Inventors: Takeshi Aikiyo, Tokyo (JP); Toshio Kimura, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD, Chiyoda-ku (JP)

(21) Appl. No.: 09/878,382

(22) Filed: Jun. 12, 2001

(30) Foreign Application Priority Data
Jun. 13, 2000 (JP) 2000-176675

(51) Int. Cl. H01S 3/04

(52) U.S. Cl. 372/36

(57) ABSTRACT

A semiconductor laser unit and a semiconductor laser module in one example of the invention improve the radiating property of heat generated from a semiconductor laser and restrain power consumption. A welding auxiliary member is fixedly attached by e.g., blazing to a stem for fixing the semiconductor laser in a position welded and joined to a cap. The cap is welded and joined to this welding auxiliary member. Thus, the stem and the cap are joined to each other through the welding auxiliary member. Since a constructional material of the stem can be selected without considering welding property, the stem can be constructed by a material having a good coefficient of thermal conductivity. Heat generated from the semiconductor laser is efficiently emitted to the exterior through the stem, and the radiating property of the generated heat of the semiconductor laser can be improved.

### BACKGROUND OF THE INVENTION

A semiconductor laser is used in large quantities as a light source for a signal and a light source for excitation in an optical fiber amplifier in optical communication. When the semiconductor laser is used as the light source for a signal and pumping source for fiber amplifier in the optical communication, the semiconductor laser is used in many cases as a semiconductor laser module in which a laser beam radiated from the semiconductor laser is optically coupled to an optical fiber.

### SUMMARY

The present invention provides a semiconductor laser unit and a semiconductor laser module using this unit in one aspect.

Namely, the semiconductor laser unit comprises:

a semiconductor laser;

a supporting member for mounting the semiconductor laser thereto;

a cap member welded and fixed to the supporting member, and internally storing the semiconductor laser; and

a welding auxiliary member interposed between the supporting member and the cap member;

wherein the supporting member has a coefficient of thermal conductivity greater than that of the welding auxiliary member.

### BRIEF DESCRIPTION OF THE DRAWINGS

Exemplify embodiments of the invention will now be described in conjunction with drawings in which:

FIGS. 1A and 1B are explanatory views typically showing one embodiment of a semiconductor laser unit in the invention.

FIG. 2 is an explanatory view typically showing one embodiment of a semiconductor laser module in the invention.

FIG. 3 is an explanatory view showing another embodiment of the invention.

FIG. 4 is an explanatory view showing one example of the semiconductor laser unit and the semiconductor laser module of a related art.

### DESCRIPTION

Related Art

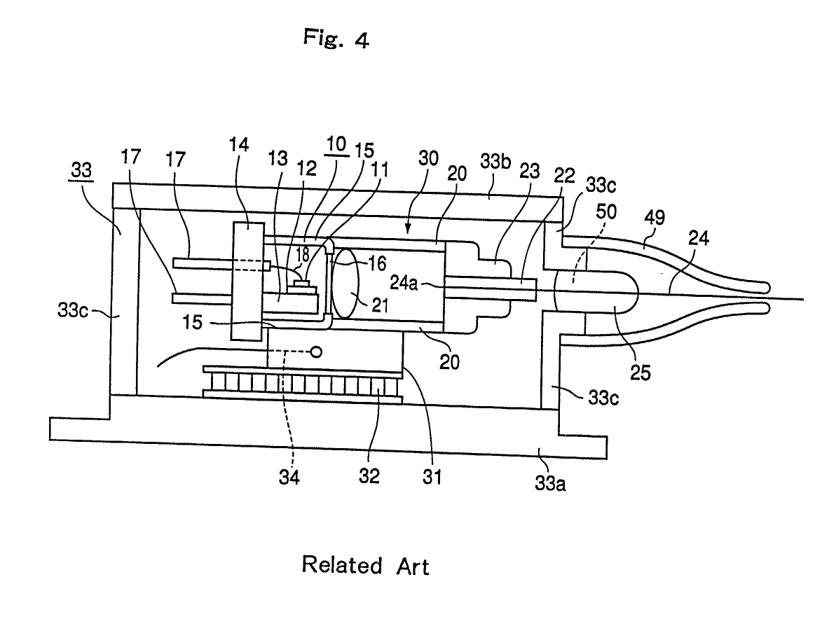

FIG. 4 typically shows one example of a semiconductor laser module related to the present application. For example, a semiconductor laser 11 is fixedly attached to a columnar stem (supporting member) 14 through a heat sink 12 made of aluminum nitride and an element fixing block 13 made of copper. A cylindrical cap (cap member) 15 made of stainless steel is joined to this stem 14 by resistance welding (projection welding). A hermetically sealed space (space portion) is formed by the stem 14 and the cap 15. The semiconductor laser 11, the heat sink 12, the element fixing block 13, etc. are stored into the hermetically sealed space.

The stem 14 is formed by iron, or an iron-nickel alloy, etc. in view of a welding facilitating property of the resistance welding. An unillustrated through hole is formed in this stem 14, and a lead pin 17 is inserted into this through hole and is fixed to this through hole by e.g., glass. This lead pin 17 and the semiconductor laser 11 are conducted and connected to each other by a gold wire 18. The semiconductor laser 11 is conducted and connected to an external circuit through the gold wire 18 and the lead pin 17. The through hole of the stem 14 is perfectly blocked by the lead pin 17 and glass for fixing the lead pin 17, thereby reliably sealing the hermetically sealed space.

An unillustrated monitor photodiode for monitoring a light emitting state of the semiconductor laser 11 is attached to the stem 14. This monitor photodiode is also stored into the hermetically sealed space, and is conducted and connected to the lead pin 17 by the gold wire, and is also conducted and connected to an external circuit. Further, a translucent window 16 for transmitting a laser beam radiated from the semiconductor laser 11 is arranged in the cap 15.

In this art shown in FIG. 4, a semiconductor laser unit 10 is constructed by the semiconductor laser 11, the heat sink 12, the element fixing block 13, the stem 14, the cap 15, the translucent window 16, the lead pin 17 and the gold wire 18.

A slide ring 23 is fixed to this semiconductor laser unit 10 through a lens holder 20 having a lens 21. A protecting cylinder 22 manufactured by stainless steel and inserting and fixing an optical fiber 24 thereto is arranged in this slide ring 23. The optical fiber 24 receives the laser beam emitted from the semiconductor laser 11. The lens 21 interposed between the semiconductor laser 11 and the optical fiber 24 is an optical coupling means for optically coupling the laser beam emitted from the semiconductor laser 11 to the optical fiber 24.

The laser beam emitted from the semiconductor laser 11 is converged by the lens 21 and is incident to the optical fiber 24. In the semiconductor laser module of this kind, a tip side of the optical fiber 24 is fixed in an aligning state in a position in which incident light intensity of this optical fiber 24 is maximized.

An internal module 30 is formed by including the semiconductor laser unit 10, the lens holder 20, the lens 21, the protecting cylinder 22, the slide ring 23 and the optical fiber 24. This internal module 30 is supported and fixed to a base 31 of a flat plate shape in a state in which a lower portion side (a drum portion of the internal module 30) of the cap 15 comes in contact with this base

A Peltier module 32 having a function for cooling the internal module 30 is arranged on a lower portion side of the base 31. This Peltier module 32 is conducted and connected to an unillustrated external control circuit. A thermistor (temperature sensor) 34 for detecting a temperature of the semiconductor laser 11 is arranged in a central portion of the base 31. This thermistor 34 is connected to the external control circuit of the Peltier module 32, and a temperature detecting signal detected by the thermistor 34 is transmitted to this external control circuit.

The internal module 30, the base 31 and the Peltier module 32 are stored into a package 33. The optical fiber 24 is guided to the package exterior from an optical fiber guide-out hole 50 formed in a side wall portion 33c of this package 33. A boot 49 for protecting the optical fiber 24 is arranged in a guide-out portion of the optical fiber 24 from the package 33. An outer circumferential side of the optical fiber 24 is covered with the boot 49. Resin 25 is arranged in the optical fiber guide-out hole 50. The optical fiber 24 is fixed and the optical fiber guide-out hole 50 is sealed by this resin 25.

The package 33 has a bottom plate portion 33a, a cover portion 33b and a side wall portion 33c. As mentioned above, the internal module 30, the base 31 and the Peltier module 32 are stored into the package 33 in a state in which the bottom plate portion 33a and the side wall portion 33c are fixed in advance. Thereafter, a circumferential edge portion of the cover portion 33b is sealed by covering the cover portion 33b. Thus, the interior of the package 33 is set to a hermetically sealed state. Plural unillustrated lead pins for conducting and connecting the interior and the exterior of the package 33 are arranged in the side wall portion 33c of the package 33. The lead pin 17 of the semiconductor laser unit 10, a lead wire pulled out of the thermistor 34, etc. are conducted and connected to the lead pins of the package side wall portion, and are then conducted and connected to a circuit outside the package.

In the semiconductor laser module of the above construction, when the semiconductor laser 11 is operated by flowing an electric current to the semiconductor laser 11 from the exterior, a laser beam is emitted from the semiconductor laser 11. This laser beam is converged by the lens 21 and is incident to an end face 24a of the optical fiber 24 as mentioned above. The laser beam is waveguided in the optical fiber 24 and is used in a predetermined desirable use.

When the semiconductor laser 11 is operated as mentioned above, heat is generated from the semiconductor laser 11. This heat is exhausted to the exterior of the semiconductor laser module 30 sequentially through the heat sink 12, the element fixing block 13, the stem 14, the cap 15, the base 31, the Peltier module 32 and the bottom plate portion 33a of the package 33. The semiconductor laser 11 is generally changed in light output and wavelength in accordance with a change in temperature. It is necessary to constantly hold the temperature of the semiconductor laser 11 so as to restrain this change in wavelength depending on temperature. Therefore, the electric current flowing through the Peltier module 32 is adjusted by the external control circuit such that the temperature detected by the thermistor 34 becomes constant. Thus, the temperature of the semiconductor laser 11 is controlled.

The stem 14 and the cap 15 are joined to each other by the resistance welding as mentioned above to reliably hermetically seal the space portion formed by the step 14 and the cap 15. As mentioned above, the stem 14 is formed by iron or an iron-nickel alloy having a small coefficient of thermal conductivity to improve welding property of the resistance welding of the stem 14 and the cap 15.

Thus, no material constituting the stem 14 has a good coefficient of thermal conductivity, and no heat generated from the semiconductor laser 11 can be efficiently radiated to the Peltier module 32 through the stem 14 so that a heat radiating property deterioration problem is caused. The temperature detected by the thermistor 34 becomes lower than the actual temperature of the semiconductor laser 11 by this heat radiating property deterioration. Therefore, the above control of the Peltier module 32 is not precisely performed on the basis of the detecting temperature of the thermistor 34.

When no control of the Peltier module 32 is precisely performed, efficiency of the semiconductor laser 11 is reduced and no high light output can be obtained. It is necessary to flow a large electric current to obtain a predetermined desirable light output from the semiconductor laser 11. Therefore, a problem of an increase in power consumption of the semiconductor laser 11 is caused by this large electric current flowing. Further, when the large electric current flows through the semiconductor laser 11, a heat generating amount of the semiconductor laser 11 is increased more and more. Therefore, a problem of an increase in power consumption of the Peltier module 32 is also caused to cool this generated heat.

In particular, as optical communication is increased in capacity, the semiconductor laser 11 of a high light output in a band of 1480 nm in oscillating wavelength is recently expected as an exciting light source of an optical fiber amplifier. Such an element has a large heat generating amount. Therefore, when the semiconductor laser module is constructed by using the semiconductor laser 11 of this kind, the problem of an increase in power consumption of the semiconductor laser 11 and the Peltier module 32 caused by a bad radiating property of heat generated from the semiconductor laser 11 is a very serious problem.

Embodiment of this Invention

The present invention provides a semiconductor laser unit and a semiconductor laser module able to efficiently radiate heat generated from a semiconductor laser and reduce and restrain power consumption in one aspect.

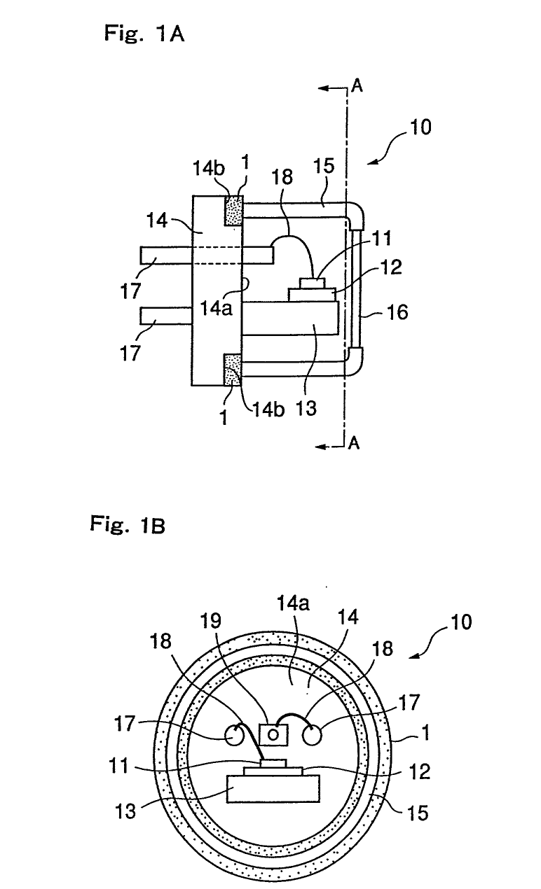

FIG. 1A shows a typical cross-sectional view of the semiconductor laser unit in one embodiment of the invention. FIG. 1B is a cross-sectional view of an A-A portion shown in FIG. 1A. In an explanation of this specification, the same reference numerals are designated in common term portions, and an overlapping explanation of the common portions is omitted or simplified.

As shown in FIGS. 1A and 1B, the semiconductor laser unit 10 in this one embodiment differs from the art of FIG. 14 in that a welding auxiliary member 1 described later is arranged in a stem 14 as a supporting member, and the stem 14 is constructed by a material (having a large coefficient of thermal conductivity) having a coefficient of thermal conductivity better than that of the welding auxiliary member 1. A reference numeral 19 designated in FIG. 1B shows a monitor photodiode for monitoring a light emitting state of the semiconductor laser 11.

In this one embodiment, a step portion 14b is formed in a circumferential edge portion of a circular semiconductor laser attaching face 14a of the stem 14, and is lower than a central portion of this semiconductor laser attaching face 14a. The welding auxiliary member 1 is formed in a ring shape fitted to the step portion 14b. The welding auxiliary member 1 is fitted to the step portion 14b of the stem 14, and is fixedly attached to this step portion 14b by e.g., blazing. A cap 15 is joined to the welding auxiliary member 1 by resistance welding, and the stem 14 is joined to the cap 15 through the welding auxiliary member 1.

As mentioned above, the welding auxiliary member 1 is joined to the cap 15 by the resistance welding. Accordingly, the welding auxiliary member 1 is constructed by a material (concretely, e.g., an alloy material of an iron-nickel system) for improving a resistance welding property to the cap 15.

For example, the welding auxiliary member is constructed by a material having a preferable welding property such as an alloy material of an iron-nickel system, etc. so that the welding property of the welding auxiliary member and the cap member can be preferably set. Thus, it is possible to reliably avoid a situation in which, for example, a crack is caused in a welding joining portion of the welding auxiliary member and the cap member, and the cap member is separated from the supporting member. Thus, mechanical reliability of the semiconductor laser unit can be improved.

In one embodiment of the invention, as mentioned above, the welding auxiliary member 1 is arranged and the cap 15 is welded and joined to the welding auxiliary member 1, and the step 14 and the cap 15 are joined to each other through the welding auxiliary member 1. The step 14 and the cap 15 are not directly welded and joined to each other. Therefore, the step 14 can be constructed by a material having a good coefficient of thermal conductivity (a large coefficient of thermal conductivity) without considering the welding property of the stem 14 and the cap 15. Accordingly, in this one embodiment, the stem 14 is constructed by a material having a coefficient of thermal conductivity better than that of the welding auxiliary member 1. For example, this material is a material having about 100 W/(m·K) or more in coefficient of thermal conductivity. Concretely, this material is copper (400 W/(m·K) in coefficient of thermal conductivity), a copper-tungsten alloy (200 W/(m·K) in coefficient of thermal conductivity in the case of Cu 20%, and 180 W/(m·K) in coefficient of thermal conductivity in the case of Cu 10%), a copper-molybdenum alloy (150 W/(m·K) in coefficient of thermal conductivity), a copper-tungsten-molybdenum alloy, etc.

In this one embodiment, similar to the stem 14, the element fixing block 13 is constructed by a high heat conducting material such as copper, a copper-tungsten alloy, a copper-molybdenum alloy, a copper-tungsten-molybdenum alloy, etc. in consideration of the heat conductivity property (heat radiating property). The element fixing block 13 and the stem 14 are preferably manufactured as integral parts by e.g., a die, etc. to simplify a manufacturing process. The welding auxiliary member 1 and the stem 14 are preferably constructed by using materials having coefficients of thermal expansion close to each other. For example, when the welding auxiliary member 1 is formed by an iron-nickel alloy or an iron-nickel-cobalt alloy and the stem 14 is formed by a copper-tungsten alloy, this alloy combination is suitable since it is easy to adjust compositions so as to set the coefficients of thermal expansion to be close to each other.

In the semiconductor laser unit 10 shown in this one embodiment, heat generated from the semiconductor laser 11 is emitted to the exterior through the heat sink 12, the element fixing block 13 and the stem 14. Since the heat sink 12, the element fixing block 13 and the stem 14 constituting this heat radiating path are constructed by materials having good heat conductivity, the radiating property of the heat generated from the semiconductor laser 11 can be greatly improved in comparison with the conventional case.

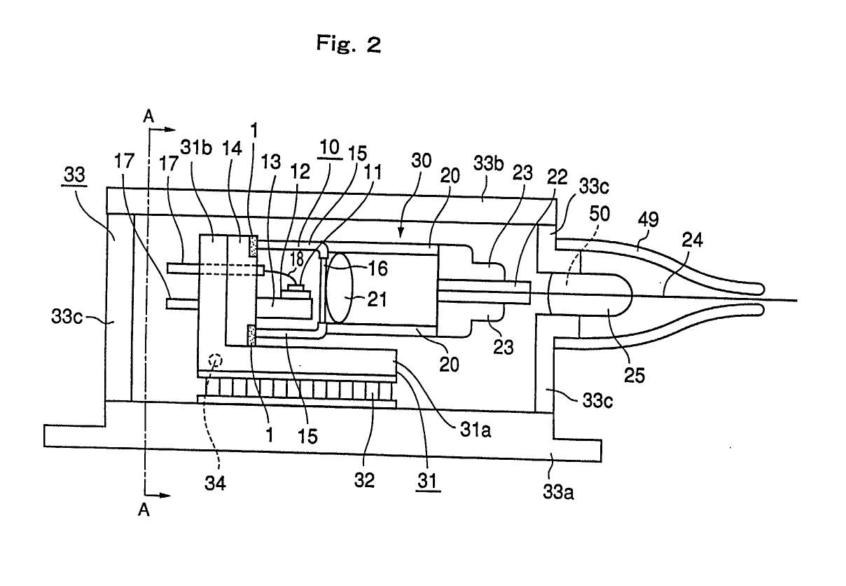

FIG. 2 shows a typical cross-sectional view showing one embodiment of a semiconductor laser module into which the semiconductor laser unit 10 shown in FIGS. 1A and 1B is assembled.

In this semiconductor laser module in one embodiment shown in FIG. 2, an internal module 30 is constructed by utilizing the semiconductor laser unit 10 shown in FIGS. 1A and 1B.

Further, in this one embodiment, a base 31 is formed in an L-shape in section. Namely, the base 31 is constructed by including a base portion 31a and a stem supporting portion 31b rising from this base portion 31a. For example, the base 31 is manufactured by a material having a preferable coefficient of thermal conductivity such as copper, a copper-tungsten alloy, etc. to improve the heat radiating property.

The base portion 31a of the base 31 is joined to the Peltier module 32 by e.g., solder, etc. The stem 14 of the semiconductor laser unit 10 is fixed to the stem supporting portion 31b of the base 31 by e.g., an adhesive. Further, an unillustrated pin insertion hole for inserting a lead pin 17 of the semiconductor laser unit 10 is formed in this stem supporting portion 31b. In this one embodiment, since an entire bottom face of the stem 14 comes in contact with the base 31 as mentioned above, heat is easily transmitted from the stem 14 to the base 31 so that the heat radiating property can be improved.

In the semiconductor laser module shown in this one embodiment, heat generated by operating the semiconductor laser 11 is transmitted to the stem supporting portion 31b of the base 31 sequentially through the heat sink 12, the element fixing block 13 and the stem 14, and is also transmitted to the Peltier module 32.

In this one embodiment, the semiconductor laser 11 is set to a semiconductor laser (a semiconductor laser in a band of 1480 nm) within a range equal to or greater than 1460 nm and equal to or smaller than 1490 nm in oscillating wavelength. For example, the semiconductor laser 11 is a light emitting element of high output and high heat generation applied for erbium dope optical fiber excitation. In the example shown in FIG. 2, a thermistor 34 is arranged in the vicinity of an intersection point of a central axis of the base portion 31a of the base 31 and a central axis of the stem supporting portion 31b.

In accordance with this one embodiment, a welding auxiliary member 1 is arranged in the stem 14, and a cap 15 is joined to this welding auxiliary member 1 by resistance welding, and the stem 14 is joined to the cap 15 through the welding auxiliary member 1. Therefore, no stem 14 is directly welded and joined to the cap 15 so that the stem 14 is formed by a material having a good coefficient of thermal conductivity without considering welding property.

Therefore, in this one embodiment, all of the heat sink 12, the element fixing block 13 and the stem 14 constituting a radiating path of generated heat of the semiconductor laser 11 are constructed by materials having good coefficients of thermal conductivity. Thus, the heat radiating property of the semiconductor laser 11 can be greatly improved in comparison with the art of FIG. 14.

Thus, in accordance with one embodiment of the invention, it is possible to prevent a problem of an increase in power consumption of the semiconductor laser 11 and the Peltier module 32 caused by deterioration of the heat radiating property so that the power consumption is reduced and the semiconductor laser unit and the semiconductor laser module of high light output can be provided.

Further, in one embodiment of the invention, the supporting member (stem) 14 of the semiconductor laser unit 10 is thermally connected to the Peltier module 32 directly or indirectly through the base 31 so that heat generated from the semiconductor laser is radiated to the Peltier module 32 through the supporting member 14 with good heat transfer property. Therefore, the temperature of the semiconductor laser 11 can be precisely controlled by the Peltier module 32. As a result, it is possible to restrain the problem of an increase in power consumption of the semiconductor laser 11 and the Peltier module 32, and the power consumption can be reduced and restrained, and the semiconductor laser module of high output can be provided.

Further, in the above one embodiment, the semiconductor laser unit 10 and the optical fiber 24 are constructed as the internal module 30 optically coupled in an aligning state. Accordingly, it is possible to reliably prevent the problem that an optical coupling state of the semiconductor laser and a tip of the optical fiber is shifted by a change in environmental temperature. Thus, stable high output can be obtained in cooperation with improving effects of the heating radiating property.

This invention is not limited to the above embodiments, but various embodiment modes can be adopted. For example, in the above embodiments, the element fixing block 13 is simultaneously manufactured integrally with the stem 14 by e.g., a die (may be also integrally formed by cutting work). However, the element fixing block 13 may be also manufactured separately and independently of the stem 14. In this case, the element fixing block 13 and the stem 14 are joined to each other by e.g., solder, etc. However, when the element fixing block 13 and the stem 14 are integrally molded as in the above embodiments, there is no joining portion between the element fixing block 13 and the stem 14 so that no problem of deterioration of the heat radiating property in the joining portion is caused and the radiating property of generated heat of the semiconductor laser 11 can be further improved.

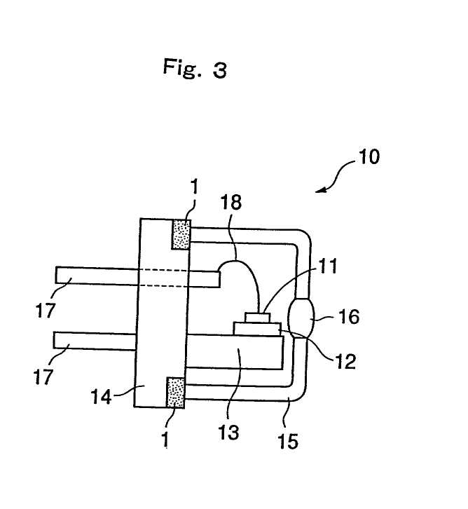

Further, in the above embodiments, the translucent window 16 is arranged in the cap 15 of the semiconductor laser unit 10 to only transmit a laser beam radiated from the semiconductor laser 11. However, for example, as shown in FIG. 3, a lens may be also arranged in this translucent window 16.

Further, in the above embodiments, the base 31 of the semiconductor laser module is formed in an L-shape in section. However, the shape of the base 31 is not limited to the shape shown in FIG. 2, but various shapes can be adopted.

Further, in the above embodiments, the welding auxiliary member 1 and the cap 15 are joined by resistance welding, but, for example, the welding auxiliary member 1 and the cap 15 may be also welded and joined by welding except for the resistance welding. Further, in the above embodiments, the semiconductor laser 11 and the optical fiber 24 are stored and arranged within the package 33 in a form of the internal module, but may not be also formed as the module.

Further, in the above embodiments, the semiconductor laser 11 is a semiconductor laser in a band of 1480 nm, but this invention can be also applied to the semiconductor laser unit and the semiconductor laser module having the semiconductor laser in a wavelength band except for this wavelength band.

What is claimed is:

1. A semiconductor laser unit comprising:
a semiconductor laser;
a supporting member for mounting the semiconductor laser thereto;
a cap member welded and fixed to the supporting member, and internally storing said semiconductor laser; and
a welding auxiliary member interposed between said supporting member and said cap member;
wherein said supporting member has a coefficient of thermal conductivity greater than that of said welding auxiliary member.

2. A semiconductor laser unit according to claim 1, wherein the welding auxiliary member is constructed by an alloy material of an iron-nickel system.

3. A semiconductor laser unit according to claim 1, wherein the supporting member is constructed by one of materials of copper, a copper-tungsten alloy, a copper-molybdenum alloy and a copper-tungsten-molybdenum alloy.

4. A semiconductor laser unit according to claim 2, wherein the supporting member is constructed by one of materials of copper, a copper-tungsten alloy, a copper-molybdenum alloy and a copper-tungsten-molybdenum alloy.

5. A semiconductor laser unit according to claim 1, wherein an oscillating wavelength of the semiconductor laser is a wavelength within a range equal to or greater than 1460 nm and equal to or smaller than 1490 nm.

6. A semiconductor laser unit according to claim 1, wherein the semiconductor laser is supported and fixed to the supporting member through an element fixing block; and
similar to the supporting member, said element fixing block is constructed by a material having a coefficient of thermal conductivity greater than that of the welding auxiliary member.

7. A semiconductor laser unit according to claim 1, wherein the cap member is joined to the welding auxiliary member by resistance welding.

8. A semiconductor laser unit according to claim 1, wherein a lens for converging and guiding a laser beam from the semiconductor laser is arranged in a translucent window of the cap member.

9. A semiconductor laser module comprising:
a package;
an optical fiber stored into said package;
a semiconductor laser unit according to claim 1 in which a semiconductor laser is stored and arranged within said package in an optical coupling state to said optical fiber; and
a Peltier module arranged on an internal bottom face side of said package and adjusting a temperature of the semiconductor laser;
wherein a supporting member of said semiconductor laser unit is thermally connected to said Peltier module directly or indirectly through a base.

10. A semiconductor laser module according to claim 9, wherein the semiconductor laser unit and the optical fiber are coupled and constitute an internal module;
the supporting member of the semiconductor laser unit is exposed to an external face of this internal module; and
said supporting member of said internal module is thermally connected to the Peltier module directly or indirectly through the base.

11. A semiconductor laser module according to claim 9, wherein a lens for optically coupling a laser beam of the semiconductor laser to the optical fiber is arranged in the internal module.
